(19) United States
(12) Patent Application Publication
(10) Pub. No.: US 2018/0283638 A1
(43) Pub. Date: Oct. 4, 2018

(54) LIGHT EMITTING DEVICE AND MOVING OBJECT

(71) Applicant: PANASONIC INTELLECTUAL PROPERTY MANAGEMENT CO., LTD., Osaka (JP)

(72) Inventors: Yusaku AJICHI, Kyoto (JP); Tomoyuki OGATA, Osaka (JP)

(73) Assignee: PANASONIC INTELLECTUAL PROPERTY MANAGEMENT CO., LT D., Osaka (JP)

(21) Appl. No.: 15/934,480

(22) Filed: Mar. 23, 2018

(30) Foreign Application Priority Data
Mar. 29, 2017 (JP) 2017-065916

(51) Int. Cl. F21S 41/24; F21S 41/67

(52) U.S. Cl. CPC F21S 41/24; F21S 41/67

(57) ABSTRACT

A light emitting device includes a light source for emitting light. A light guide includes an entrance surface that receives the light emitted from the light source. The light guide is configured to guide the received light along a length thereof in a direction away from the light source and to allow a part of the guided light to emerge outside of the light guide. A facing member includes a facing surface that extends along the length of the light guide and faces the light guide. The facing member is configured to be illuminated by the part of the light emerging outside of the light guide. At least one part of the facing member is configured to increase in luminance of the facing surface in accordance with an increase in a distance from the light source along the length of the light guide.

### CROSS-REFERENCE TO RELATED APPLICATION

The present application is based upon and claims the benefit of priority of Japanese Patent Application No. 2017-065916, filed on Mar. 29, 2017, the entire contents of which are incorporated herein by reference.

### TECHNICAL FIELD

The present disclosure relates to light emitting devices and moving objects, and in particularly to a light emitting device including a light guide, and a moving object including the light emitting device.

### BACKGROUND ART

A vehicular lamp (lid lamp) disclosed in Document 1 (JP 2017-16935 A) is taken as a conventional example. This conventional example includes a light emitting diode (LED) serving as a light source, a substrate where the LED is mounted, a light guide for guiding light from LED along the entire length thereof, and a reflector disposed in back of the light guide.

The light guide is formed into a long and narrow bar shape of light-transmissive resin such as acrylic resin with translucency. One end surface in the lengthwise direction of the light guide is used as an entrance surface. The LED is placed opposite the entrance surface. Part of the peripheral surface of the light guide is used as an exit surface and an opposite surface thereof is used as an opposite exit surface. And, there are multiple cuts (incisions) in triangular prism shape (saw blade shape) formed continuously in the opposite exit surface of the light guide.

In the conventional example, light emitted from the LED enters the inside of the light guide through the entrance surface of the light guide. Thereafter, the light travels inside the light guide along the length of the light guide and is reflected and/or refracted by the cuts formed in the opposite exit surface of the light guide to thereby emerge outside through the exit surface. In the conventional example, the multiple cuts are formed continuously in the opposite exit surface of the light guide, and this may lead to an increase in uniformity of luminance of light emerging outside via the exit surface of the light guide.

Since it is necessary to form the multiple cuts in the opposite exit surface of the light guide, conventional example disclosed in Document 1 faces a problem of an increase in the production cost of the light guides.

The object of aspects according to the present disclosure would be to propose a light emitting device and a moving object which are capable of improving uniformity of luminance while suppressing an increase in production cost.

### SUMMARY

The light emitting device of one aspect according to the present disclosure includes: a light source for emitting light; and a light guide having a length and including an entrance surface, the entrance surface for receiving the light emitted from the light source, the light guide configured to guide the light received via the entrance surface along the length in a direction away from the light source and to allow a part of the light guided along the length to emerge outside of the light guide. The light emitting device of the aspect further includes a facing member including a facing surface, the facing surface extending along the length of the light guide and facing the light guide, the facing member configured to be illuminated by the part of the light emerging outside of the light guide. At least one part of the facing member is configured to increase in luminance of the facing surface in accordance with an increase in a distance from the light source along the length of the light guide.

The moving object of one aspect according to the present disclosure includes: the light emitting device; and a body in which the light emitting device is mounted.

The light emitting device of one aspect according to the present disclosure includes a light guide having a length and including an entrance surface, the entrance surface for receiving light emitted from a light source, the light guide configured to guide the light received via the entrance surface along the length in a direction away from the light source and to allow a part of the light guided along the length to emerge outside of the light guide. The light emitting device of the aspect further includes a facing member including a facing surface, the facing surface extending along the length of the light guide and facing the light guide, the facing surface configured to be illuminated by the part of the light emerging outside of the light guide. At least one part of the facing member is configured to increase in luminance of the facing surface in accordance with an increase in a distance from the light source along the length of the light guide.

### BRIEF DESCRIPTION OF THE DRAWINGS

The figures depict one or more implementation in accordance with the present teaching, by way of example only, not by way of limitations. In the figures, like reference numerals refer to the same or similar elements.

FIG. 1 is a perspective view of a light emitting device of Embodiment 1 according to the present disclosure.

FIG. 2A is a partial front view of a facing member of the above light emitting device.

FIG. 2B is a partial front view of another facing member of the above light emitting device.

FIG. 2C is a partial front view of another facing member of the above light emitting device.

FIG. 3 is a graph of luminance distribution of a light emitting surface of the above light emitting device.

FIG. 4 is a perspective view of a modification of the light emitting device of the above.

FIG. 5 is a side view of a light emitting device of Embodiment 2 according to the present disclosure.

FIG. 6 is a side view of a light emitting device of Embodiment 3 according to the present disclosure.

FIG. 7A is a partial perspective view of a light emitting device of Embodiment 4 according to the present disclosure.

FIG. 7B is a partial front view of a main light guide and an auxiliary light guide of the above light emitting device.

FIG. 8 is a perspective view of a moving object (vehicle) of one embodiment according to the present disclosure.

FIG. 9 is a front view of a component (door) of the above moving object of the above including the above light emitting device.

### DETAILED DESCRIPTION

Detailed descriptions referring to the attached drawings would be made to embodiments of light emitting devices according to the present disclosure and embodiments of vehicles according to the present disclosure. Note that, configurations described in relation to the following embodiments are just examples of the present disclosure. The embodiments in a range of the present disclosure are not limited to the following embodiments only, and the following embodiments would be modifies in various ways according to design or other reasons as long as they can achieve the technical effects of the present disclosure.

### Embodiment 1 of Light Emitting Device

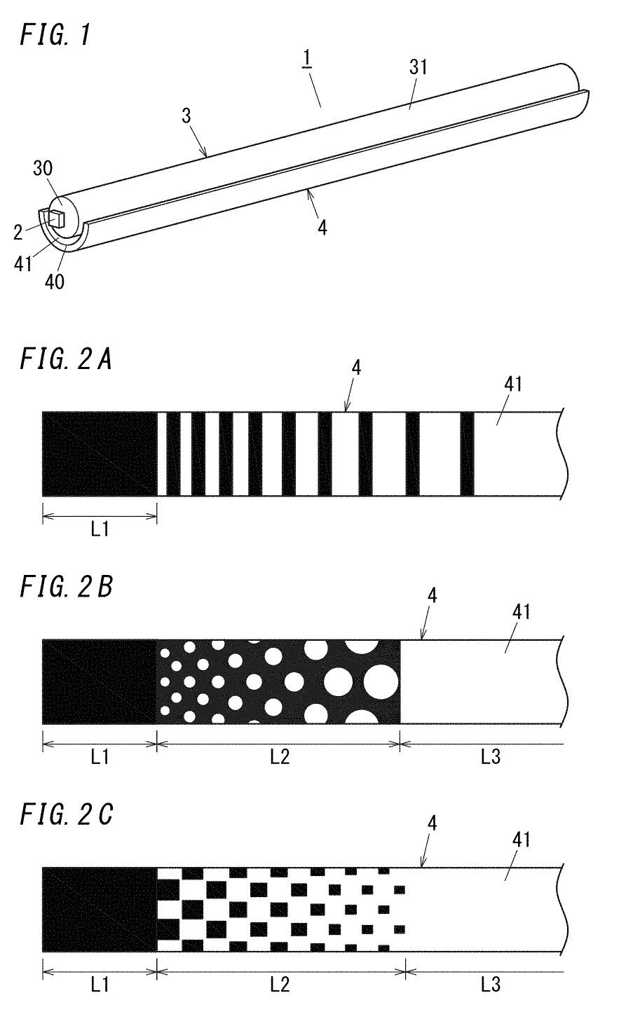

FIG. 1 shows a light emitting device 1 of Embodiment 1 which includes a light source 2 for emitting light, a light guide 3 having a length, and a facing member 4. The light source 2 may be constituted by one or more packaged light emitting diodes, for example. However, the light source 2 may not be limited to light emitting diodes, but may be other solid light sources such as laser diodes and organic electroluminescence elements. And, light emitted from the light source 2 may be white light, red light, green light, blue light, or any other light.

The light guide 3 is formed into a bar shape (circular cylindrical shape) of material light-transmissive (translucent) for visible light such as acrylic resin, polycarbonate resin, and fluorine resin. However, the shape of the light guide 3 may not be limited to a circular cylindrical shape, but may be various shapes such as a prismatic shape. One of end surfaces of the light guide 3 serves as an entrance surface 30. Alternatively, the both end surfaces of the light guide 3 may each serve as an entrance surface. The light guide 3 is designed to guide light coming inside via the entrance surface 30 (light emitted from the light source 2) while allowing part of the light to emerge to an outside (outside of the light guide 3) via a peripheral surface 31. Alternatively, the light guide 3 may include a core and cladding which is made of dielectric material with a lower refractive index than the core and surrounds the core. In one example, the core may be made of acrylic resin and the cladding may be made of fluorine resin. Or, the core may be made of polycarbonate resin and the cladding may be made of fluorine resin. According to the light guide 3 with such a structure, part of light entering the core through the entrance surface 30 is totally reflected by an interface between the core and the cladding and then travels in a direction away from the entrance surface 30, and other part of light which is not totally reflected by the interface passes though the cladding and emerges to an outside the light guide 3.

The facing member 4 is formed into a trough shape with a semi-cylindrical recess 40 and is made of synthetic resin material, for example. However, the facing member 4 may be made of material other than synthetic resin material, and examples of such material may include metal and ceramic. The light guide 3 is inserted in the recess 40 of the facing member 4. The facing member 4 supports the light guide 3 inserted in the recess 40. This means that the facing member 4 also serves as a support for supporting the light guide 3. Note that, it may be preferable that the facing member 4 is designed to support the light source 2 to face the entrance surface 30 of the light guide 3. Further, in the state where the light guide 3 is inserted, an inner peripheral surface of the recess 40 plays a role of a facing surface 41 facing (opposite) the light guide 3. Alternatively, the light emitting device 1 may include a support which is a separate part from the facing member 4 and supports the light source 2, the light guide 3, and the facing member 4.

In this regard, at least one part of the facing member 4 is designed to increase luminance at the facing surface 41 with an increase in a distance from the light source 2 along the length of the light guide 3. For example, the facing member 4 is designed to have the facing surface 41 a reflectivity at a region of which changes from a lower value (e.g., zero) to a higher value with an increase in the distance from the light source 2 to the region along the length of the light guide 3. Concrete examples of configuration of the facing member 4 are illustrated in FIG. 2A to FIG. 2C. In each of the facing members 4 shown in FIG. 2A to FIG. 2C, a region (a first region L1) which is closest to the light source 2 along the length in the facing surface 41 is painted black wholly, to have a reflectivity close to zero. In the facing member 4 shown in FIG. 2A, a region other than the first region L1 of the facing surface 41 is printed with stripe pattern in which pitches between black strips gradually increase in proportion to the distances from the light source 2 to the black strips along the length. In the facing member 4 shown in FIG. 2B, a region (a second region L2) which is further from the light source 2 along the length in the facing surface 41 than the first region L1 is printed with polka-dot pattern in which white round dots are on a black background, and a region (a third region L3) is painted white wholly. The third region L3 is further from the light source 2 than the second region L2 along the length. Additionally, in the second region L2, the dots have diameters increasing in proportion to the distances from the light source 2 to the dots along the length. In the facing member 4 shown in FIG. 2C, the second region L2 which is further from the light source 2 along the length in the facing surface 41 than the first region L1 is printed with lattice pattern, and the third region L3 is painted white wholly. The third region is further from the light source 2 than the second region L2 along the length. Additionally, in the second region L2, the lattice pattern has black parts with areas decreasing in proportion to the distances from the light source 2 to the black parts along the length. Alternatively, the first region L1 and the third region L3 may be painted in color other than black and white, such as achromatic color (e.g., gray).

In summary, each of the facing members 4 illustrated in FIG. 2A to FIG. 2C is designed so that a reflectivity per unit area of the first region L1 in the facing surface 41 is substantially zero. As to the facing member 4 illustrated in FIG. 2A, a reflectivity (average) per unit area of the region except the first region L1 increases in proportion to the pitch of the stripe pattern. Further, in each of the facing members 4 shown in FIG. 2B and FIG. 2C, the reflectivities (averages) per unit area of the second region L2 and the third region L3 increase with an increase in a ratio of white parts (parts with higher reflectivity).

Next, operations of the light emitting device 1 of Embodiment 1 are described. Light emitted from the light source 2 enters the light guide 3 via the entrance surface 30. The light which has entered the light guide 3 travels inside the light guide 3 along the length of the light guide 3 away from the light source 2. Further, some amount of the light traveling inside the light guide 3 emerges to the outside of the light guide 3 via the peripheral surface 31 of the light guide 3. However, an amount of light (luminous flux) emerging through a region of the peripheral surface 31 of the light guide 3 decreases monotonically with an increase in the distance from the light source 2 to the region. Light which is part of the light emerging through the peripheral surface 31 of the light guide 3 and travels toward the facing member 4 is reflected by the facing surface 41 of the facing member 4 and thereafter passes through the light guide 3 and emerges through the peripheral surface 31 of the light guide 3 again. In summary, luminance of the light emitting surface of the light emitting device 1 is in proportion to a total of luminous flux directly emerging through the peripheral surface 31 of the light guide 3 (that is, luminous flux emerging without being reflected by the facing surface 41) and luminous flux emerging through the peripheral surface 31 of the light guide 3 after reflected by the facing surface 41. In other words, the luminance of the light emitting surface of the light emitting device 1 is equal to the sum of luminance given by luminous flux emitted from the light emitting surface except luminous flux emitted from the facing surface 41, and luminance given by luminous flux emitted from the facing surface 41. Additionally, luminance of the facing surface 41 is in proportion to reflectivity of the facing surface 41 as long as luminous flux striking the facing surface 41 is kept constant. Therefore, luminous distribution of the facing surface 41 versus the distance from the light source 2 shows that luminance at a point increases with an increase in the distance from the light source 2 to the point like the distribution of reflectivity.

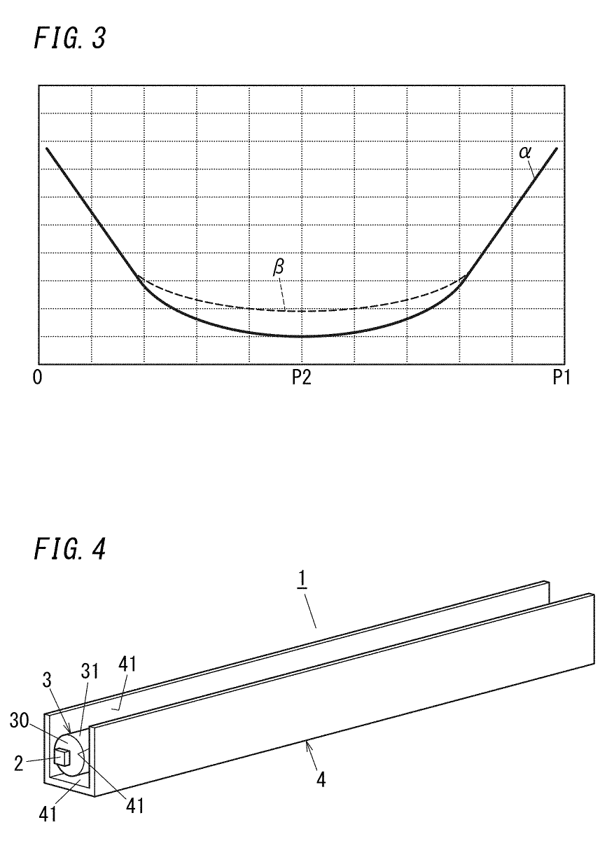

FIG. 3 shows a result of comparison in the distribution of luminance of the light emitting surface of the light emitting device 1 between one case where the distribution of luminance of the facing surface 41 is uniform (the reflectivity of the facing surface 41 is constant) and another case where the distribution of luminance of the facing surface 41 shows the luminance at a point increasing as the distance from the light source 2 to the point increases. The horizontal axis of FIG. 3 denotes the distance of a point in the light emitting surface from the light source 2, and the vertical axis of FIG. 3 denotes the luminance at a point in the light emitting surface of the light emitting device 1. Note that, the result of comparison shown in FIG. 3 relates to arrangement where the opposite end surfaces in the length of the light guide 3 serves as the individual entrance surfaces 30 and rays of light emitted from different light sources 2 strike the individual entrance surfaces 30. Note that, a location where one light source 2 (first light source) is positioned corresponds to a point of origin in the horizontal axis, and a location where another one light source (second light source) is positioned corresponds to point P1 in the horizontal axis, and a position equidistant from the two light sources (the first light source and the second light source) corresponds to point P2 in the horizontal axis.

In FIG. 3, solid line α indicates the distribution of luminance of the light emitting surface of the light emitting device 1 in a condition where the distribution of luminance of the facing surface 41 is uniform. The distribution of luminance indicated by solid line α shows that luminance is the highest at the point of origin and point P1 each of which is closest to a corresponding one of the light sources 2. The luminance at a point in the light emitting surface decreases with an increase in the distance from the light source 2 to the point. At point P2 equidistant from the point of origin and point P1 the luminance is the lowest.

In FIG. 3, broken line β indicates the distribution of luminance of the light emitting surface of the light emitting device 1 in a condition where the distribution of luminance of the facing surface 41 shows the luminance at a point increases with an increase in a distance from the light source 2 to the point. The distribution of luminance indicated by broken line β shows that luminance is the highest at the point of origin and point P1 each of which is closest to a corresponding one of the light sources 2 and the luminance is the lowest at point P2 like the distribution of luminance represented by solid line α. However, in the distribution of luminance indicated by broken line β, the luminance at the point becomes higher than the luminance at the same point in the distribution of luminance given by solid line α as the point moves from P1 to P2. Accordingly, this leads to a decrease in a difference (luminance difference) between the highest difference and the lowest difference. In summary, the light emitting device 1 of Embodiment 1 can uniform the distribution of luminance of the light emitting surface (improve the uniformity of luminance) compared with a case where the facing surface 41 of the facing member 4 has the uniform distribution of luminance (or the facing member 4 is absent). Additionally, in contrast to the conventional example disclosed in Document 1, the light emitting device 1 of Embodiment 1 does not need subjecting the light guide 3 to special treatment (forming the multiple cuts in the opposite exit surface of the light guide), and this leads to suppression of an increase in the production cost.

FIG. 4 shows Modification 1 of the light emitting device 1 of Embodiment 1. In the light emitting device 1 according to Modification 1, the facing member 4 may be formed into a prismatic trough shape. The internal side surfaces of the facing member 4 serve as the facing surface 41. The facing member 4 may be preferably designed to increase the reflectivity at a region of the facing surface 41 with an increase in the distance from the light source 2 to the region to increase the luminance of the facing surface 41. Alternatively, the facing member 4 may be designed so that luminance at a point in part of the facing surface 41 corresponding to a bottom surface of the internal side surfaces constituting the facing member 4 changes according to the distance from the light source 2 to the point.

In an alternative case where the light emitting device 1 includes a support which is a separate part from the facing member 4, the facing member 4 may be preferably formed into a simple shape such as a flat plate shape. If the facing member 4 is formed into a simple shape, it is possible to facilitate a process of changing the distribution of luminance of the facing surface 41 of the facing member 4 along the length of the facing member 4. Note that, the facing member 4 may be preferably fixed to the support by appropriate methods such as bonding and swaging.

### Embodiment 2 of Light Emitting Device

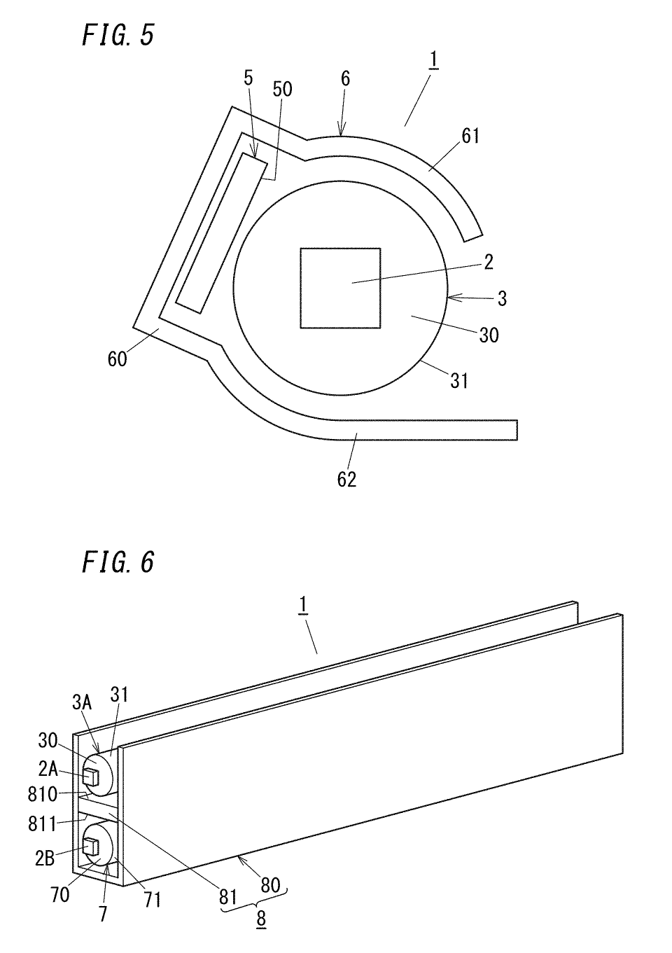

FIG. 5 shows a light emitting device 1 of Embodiment 2, which includes the light source 2, the light guide 3, the facing member 5, and the support 6. Note that, components common to the light emitting device 1 of Embodiment 2 and the light emitting device 1 of Embodiment 1 are designated by the common reference signs to appropriately omit descriptions thereof.

The facing member 5 is formed into an elongated rectangular flat plate shape of synthetic resin material with light transmissivity such as acrylic resin, polycarbonate resin, and fluorine resin.

The support 6 includes: an accommodating part 60 formed into a rectangular trough shape to accommodate the facing member 5; a first side wall 61 protruding from the first end in the length of the accommodating part 60; and a second side wall 62 protruding from the second end in the length of the accommodating part 60. The first side wall 61 and the second side wall 62 are formed into a shape of an elongated plate warping along the length (direction vertical to the sheet of FIG. 5) like an arc. The support 6 is designed to accommodate the light guide 3 in an inside space surrounded by the first side wall 61 and the second side wall 62. Note that, the facing member 5 may be preferably fixed to the support 6 by appropriate methods such as bonding and swaging.

Additionally, an inner bottom surface of the accommodating part 60 faces the light guide 3 with the facing member 5 in-between. The inner bottom surface of the accommodating part 60 is formed as a reflective surface with a reflectivity equal to or higher than 80%, for example. In the light emitting device 1 of Embodiment 2, the accommodating part 60 of the support 6 plays a role of a reflector.

While, at least one part of the facing member 5 is designed to increase luminance at a point in the facing surface 50 facing the light guide 3 with an increase in the distance from the light source 2 to the point along the length of the light guide 3. For example, the facing member 5 is designed so that a reflectivity at a region thereof changes from a lower value (e.g., zero) to a higher value with an increase in the distance from the light source 2 to the region along the length of the light guide 3. For example, in a similar manner to the facing member 4 in the light emitting device 1 of Embodiment 1, a region which is closest to the light source 2 along the length in the facing surface 50 of the facing member 5 is painted black wholly, to have a reflectivity close to zero. In addition, a region other than the region painted black of the facing surface 50 is printed with stripe pattern in which pitches between black strips gradually increase in proportion to the distance from the light source 2 to the black strips. Alternatively, printing may be done with polka-dot pattern, lattice pattern, or the like, instead of the stripe pattern.

Next, how the light emitting device 1 of Embodiment 2 works is described. Light emitted from the light source 2 enters the light guide 3 via the entrance surface 30. The light which has entered the light guide 3 travels inside the light guide 3 along the length of the light guide 3 away from the light source 2. Further, some amount of the light traveling inside the light guide 3 emerges to the outside of the light guide 3 via the peripheral surface 31 of the light guide 3. Light which is part of the light emerging through the peripheral surface 31 of the light guide 3 and travels toward the facing member 5 passes through the facing member 5 and thereafter is reflected by the reflective surface (the inner bottom surface of the accommodating part 60) of the reflector (the accommodating part 60). Subsequently the light passes through the facing member 5 again and emerges to the outside of the light guide 3 via the peripheral surface 31 of the light guide 3 again. In this regard, luminance at a point in the light emitting surface (the peripheral surface 31 of the light guide 3 exposed between the first side wall 61 and the second side wall 62) of the light emitting device 1 decreases as the distance from the light source 2 to the point increases. However, luminance at a point in the facing surface 50 of the facing member 5 becomes higher as the distance from the light source 2 to the point becomes longer. Accordingly, a decrease in the luminance at the light emitting surface of the light emitting device 1 is suppressed and this can lead to improvement of uniformity of luminance. Consequently, the light emitting device 1 of Embodiment 2 also can improve uniformity of luminance while suppressing an increase in production cost like the light emitting device 1 of Embodiment 1.

### Embodiment 3 of Light Emitting Device

FIG. 6 shows a light emitting device 1 of Embodiment 3, which includes two light sources (a main light source 2A and an auxiliary light source 2B), two light guides (a main light guide 3A and an auxiliary light guide 7), and a support 8. Note that, components common to the light emitting device 1 of Embodiment 3 and the light emitting device 1 of Embodiment 1 are designated by the common reference signs to appropriately omit descriptions thereof.

The main light source 2A and the auxiliary light source 2B each may be constituted by one or more packaged light emitting diodes, like the light source 2 of the light emitting device 1 of Embodiment 1. However, each of the main light source 2A and the auxiliary light source 2B may not be limited to light emitting diodes, but may be other solid light sources such as laser diodes and organic electroluminescence elements. And, light emitted from each of the main light source 2A and the auxiliary light source 2B may be white light, red light, green light, blue light, or any other light. However, light (first light) emitted from the main light source 2A and light (second light) emitted from the auxiliary light source 2B may preferably be the same type of light (considered to have the same color).

Each of the main light guide 3A and the auxiliary light guide 7 is formed into a bar shape (circular cylindrical shape) of material such as acrylic resin, polycarbonate resin, and fluorine resin, like the light guide 3 of the light emitting device 1 of Embodiment 1. However, the shape of each of the main light guide 3A and the auxiliary light guide 7 may not be limited to a circular cylindrical shape, but may be various shapes such as a prismatic shape. One end surfaces of the main light guide 3A and the auxiliary light guide 7 serve as entrance surfaces 30 and 70 (referred to as an “auxiliary entrance surface 70”), respectively. Alternatively, the both end surfaces of each of the main light guide 3A and the auxiliary light guide 7 may each serve as an entrance surface. The main light guide 3A and the auxiliary light guide 7 are designed to guide light coming inside via the entrance surfaces 30 and 70 while allowing part of the light to emerge to an outside (outsides of the main light guide 3A and the auxiliary light guide 7) via the peripheral surfaces 31 and 71, respectively. Alternatively, each of the main light guide 3A and the auxiliary light guide 7 may include a core and cladding which is made of dielectric material with a lower refractive index than the core and surrounds the core.

The support 8 includes a body 80 and a facing member 81. The body 80 is formed into a rectangular trough shape and is made of synthetic resin material, for example. However, the body 80 may be made of material other than synthetic resin material, and examples of such material may include metal and ceramic. Preferably, an inner bottom surface and inner side surfaces of the body 80 may function as a reflective surface with a reflectivity equal to or higher than 80%, for example. The facing member 81 is formed into an elongated rectangular plate shape of material which is light-transmissive (translucent) for visible light, such as acrylic resin, polycarbonate resin, and fluorine resin. The facing member 81 is positioned inside the body 80 to divide an inside space of the body 80 into two substantially equal inside spaces.

The support 8 accommodates and supports the main light guide 3A and the auxiliary light guide 7 in the inside space closer to an open end of the body 80, and the inside space closer to a bottom of the body 80, of the two divided inside spaces of the body 80 by the facing member 81, respectively. Note that, the support 8 may preferably be designed to support the main light source 2A and the auxiliary light source 2B to individually face the entrance surfaces 30 and 70 of the main light guide 3A and the auxiliary light guide 7. In the following description, a facing surface which is one of two opposite surfaces of the facing member 81 and faces the peripheral surface 31 of the main light guide 3A is referred to as a main facing surface 810, and another facing surface which is one of the two opposite surfaces of the facing member 81 and faces the peripheral surface 71 of the auxiliary light guide 7 is referred to as an auxiliary facing surface 811.

In this regard, at least one part of the facing member 81 is designed to increase luminance at a point in the main facing surface 810 with an increase in the distance from the light source (the main light source 2A and the auxiliary light source 2B) to the point along the length (first length) of the main light guide 3A. In a concrete example, the facing member 81 is designed so that a reflectivity at a region thereof changes from a lower value (e.g., zero) to a higher value with an increase in the distance from the light source to the region along the length of the main light guide 3A. For example, in a similar manner to the facing member 4 in the light emitting device 1 of Embodiment 1, a region which is closest to the main light source 2A along the length in the main facing surface 810 of the facing member 81 is painted black wholly, to have a reflectivity close to zero. In addition, a region other than the region painted black of the main facing surface 810 is printed with stripe pattern in which pitches between black strips gradually increase in proportion to the distance from the light source to the black strips. Alternatively, printing may be done with polka-dot pattern, lattice pattern, or the like, instead of the stripe pattern.

The following description is made to operations to the light emitting device 1 of Embodiment 3. Light emitted from the main light source 2A enters the main light guide 3A via the entrance surface 30. The light which has entered the main light guide 3A travels inside the main light guide 3A along the length of the main light guide 3A away from the main light source 2A. Further, a part (first part) of the light (first light) traveling inside the main light guide 3A emerges to the outside of the main light guide 3A via the peripheral surface 31 of the main light guide 3A. Meanwhile, light emitted from the auxiliary light source 2B enters the auxiliary light guide 7 via the entrance surface 70. The light which has entered the auxiliary light guide 7 travels inside the auxiliary light guide 7 along the length (second length) of the auxiliary light guide 7 away from the auxiliary light source 2B. Further, a part (second part) of the light (second light) traveling inside the auxiliary light guide 7 emerges to the outside of the auxiliary light guide 7 via the peripheral surface 71 of the auxiliary light guide 7. Light which is part of the light emerging through the peripheral surface 71 of the auxiliary light guide 7 and travels toward the facing member 81 passes through the facing member 81 and thereafter emerges to the outside of the main light guide 3A via the peripheral surface 31 of the main light guide 3A. Luminance at a point in the light emitting surface (the peripheral surface 31 of the main light guide 3A exposed from the body 80 of the support 8) of the light emitting device 1 decreases as the distance from the light source to the point increases. However, luminance at a point in the facing surface 810 of the main facing member 81 becomes higher as the distance from the light source to the point becomes longer. Accordingly, a decrease in the luminance at the light emitting surface of the light emitting device 1 is suppressed and this can lead to improvement of uniformity of luminance. Consequently, the light emitting device 1 of Embodiment 3 also can improve uniformity of luminance while suppressing an increase in production cost like the light emitting devices 1 of Embodiments 1 and 2.

### Embodiment 4 of Light Emitting Device

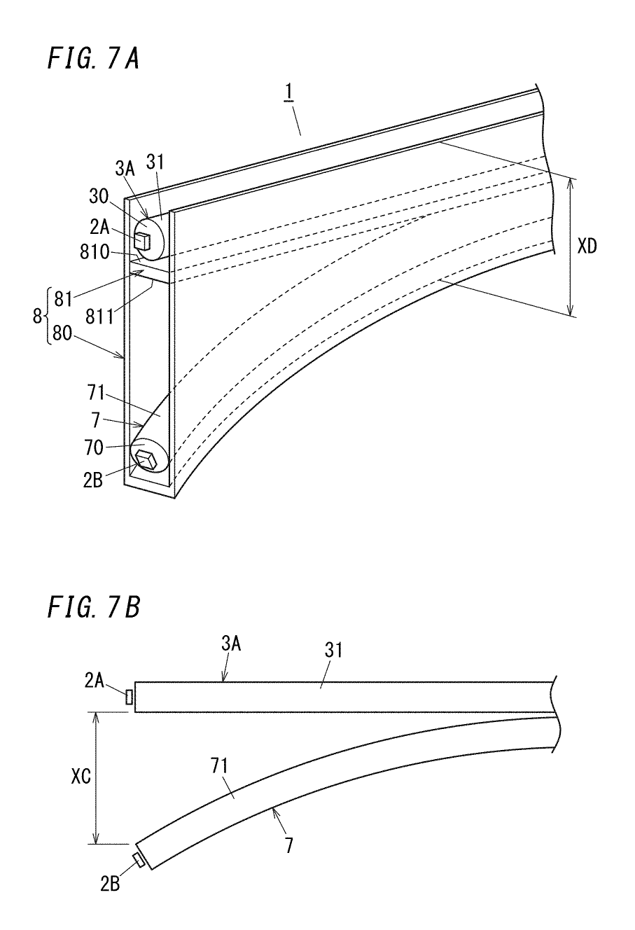

FIG. 7A shows a light emitting device 1 of Embodiment 4, which includes the two light sources (the main light source 2A and the auxiliary light source 2B), the two light guides (the main light guide 3A and the auxiliary light guide 7), and the support 8. Note that, components common to the light emitting device 1 of Embodiment 4 and the light emitting device 1 of Embodiment 3 are designated by the common reference signs to appropriately omit descriptions thereof.

The body 80 of the support 8 is designed to have a depth XD at part which gradually increases as the part comes close to the nearest end in the length thereof (see FIG. 7A). The body 80 accommodates and supports the auxiliary light guide 7 in the inside space closer to the bottom of the body 80, of the two divided inside spaces of the body 80 by the facing member 81. The auxiliary light guide 7 is supported on the body 80 in a condition where it warps along the inner bottom surface of the body 80. Note that, the facing member 81 is designed to have uniform transmissivities in regions irrespective of the distance from the main light source 2A to the regions.

Hereinafter, operations of the light emitting device 1 of Embodiment 4 are described. Light emitted from the main light source 2A enters the main light guide 3A via the entrance surface 30. The light which has entered the main light guide 3A travels inside the main light guide 3A along the length of the main light guide 3A away from the main light source 2A. Further, some amount of the light traveling inside the main light guide 3A emerges to the outside of the main light guide 3A via the peripheral surface 31 of the main light guide 3A. Meanwhile, light emitted from the auxiliary light source 2B enters the auxiliary light guide 7 via the entrance surface 70. The light which has entered the auxiliary light guide 7 travels inside the auxiliary light guide 7 along the length of the auxiliary light guide 7 away from the auxiliary light source 2B. Further, some amount of the light traveling inside the auxiliary light guide 7 emerges to the outside of the auxiliary light guide 7 via the peripheral surface 71 of the auxiliary light guide 7. Light which is part of the light emerging through the peripheral surface 71 of the auxiliary light guide 7 and travels toward the facing member 81 passes through the facing member 81 and thereafter emerges to the outside of the main light guide 3A via the peripheral surface 31 of the main light guide 3A. Luminance at a point in the light emitting surface (the peripheral surface 31 of the main light guide 3A exposed from the body 80 of the support 8) of the light emitting device 1 decreases as the distance from the light source (the main light source 2A) to the point increases. However, a distance XC between the facing member 81 and the peripheral surface 71 of the auxiliary light guide 7 becomes shorter as the distance from the light source becomes longer, and this may lead to suppression of a decrease in luminous flux passing through the facing member 81. Therefore, luminance at a point in the facing surface 810 of the facing member 81 becomes higher as the distance from the light source to the point becomes longer. Accordingly, a decrease in the luminance at the light emitting surface of the light emitting device 1 is suppressed and this can lead to improvement of uniformity of luminance. Note that, the light emitting device 1 of the present embodiment may see an increase in the production cost due to presence of two light guides, compared with a case where there is a single light guide. However, the light emitting device 1 of the present embodiment does not need subjecting the individual light guides to special treatment, and thus can suppress an increase in the production cost compared with a case where there are two light guides subjected to the special treatment process like the conventional example. Consequently, the light emitting device 1 of Embodiment 4 also can improve uniformity of luminance while suppressing an increase in production cost like the light emitting devices 1 of Embodiments 1 to 3.

### Embodiment of Moving Object

One embodiment of a moving object according to the present disclosure is described with reference to attached drawings. The moving object of the present embodiment is a vehicle moving on land. Note that, the moving object of the present embodiment may not be limited to such a vehicle but may be an air plane or a ship.

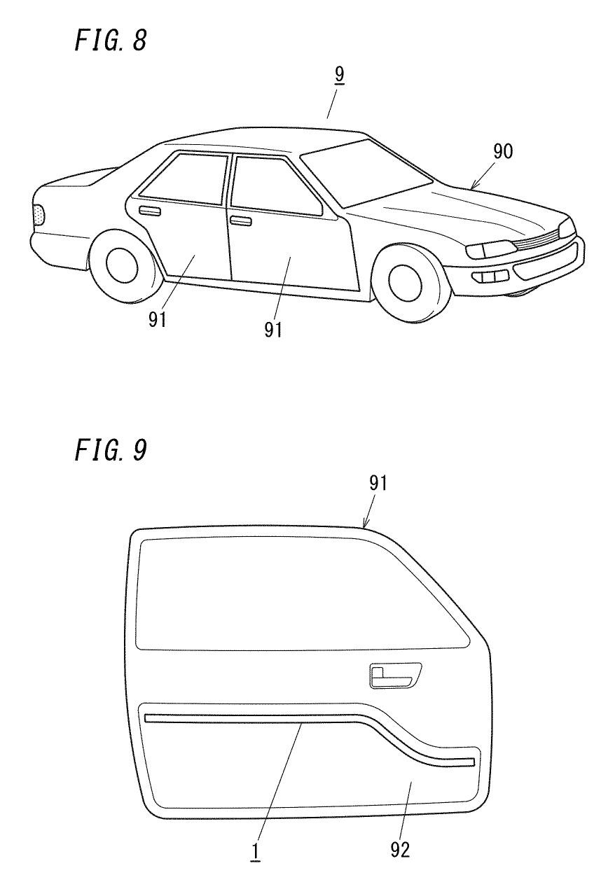

As shown in FIG. 8, the present embodiment relates to a vehicle 9 which may preferably be an automobile such as a sedan including a vehicular body 90 equipped with four doors 91.

At least any one of the light emitting devices 1 of Embodiments 1 to 4 is attached to at least one of the doors 91 of the vehicle 9 of the present embodiment (see FIG. 9). The light emitting device 1 is attached to a side surface of the door trim 92 provided on an inner side (vehicular interior side) of the door 91. Note that, just part of the light emitting surface of the light emitting device 1 is exposed on the side surface of the door trim 92. Part (e.g., the light source 2 and the supports 6 and 8) of the light emitting device 1 which is not exposed on the side surface of the door trim 92 is accommodated in a space between the door trim 92 and a door panel constituting an external wall of the door 91. The light emitting device 1 attached to the door 91 emits light via the light emitting surface exposed on the side surface of the door trim 92. Thereby, the door trim 92 can be decorated with a line of light. In this regard, the part of the light emitting device 1 accommodated in the space between the door panel and the door trim 92 may not necessarily be designed so that the distributions of luminance of the facing surfaces 41, 50, and 810 of the facing members 4, 5, and 81 show that luminance at a point increases with an increase in the distance from the light source to the point. Additionally, a location where the light emitting device 1 is attached may not be limited to the side surface of the door trim 92. For example, the light emitting device 1 may be attached to the door panel serving as the external wall of the door 91.

Components of the light emitting devices 1 of Embodiments 1 to 4 described above may not include the light source 2. Further, as to the light emitting device 1 of Embodiment 4, light emitted from one light source 2 may be separated into multiple rays of light by a splitter and the multiple rays of light may be sent to the main light guide 3A and the auxiliary light guide 7. In short, the entrance surface 70 of the auxiliary light guide 7 may receive light from a light source (the main light source 2A) or a different light source (the auxiliary light source 2B) from said light source (the main light source 2A).

As apparent from the above, the light emitting device (1) of the first aspect according to the present disclosure includes: a light source (2) for emitting light; and a light guide (3) having a length and including an entrance surface (30), the entrance surface (30) for receiving the light emitted from the light source (2), the light guide (3) configured to guide the light received via the entrance surface (30) along the length in a direction away from the light source (2) and allow a part of the light guided along the length to emerge outside of the light guide (3). The light emitting device (1) of the first aspect further includes a facing member (4) including a facing surface (41), the facing surface (41) extending along the length of the light guide (3) and facing the light guide (3). The facing member (4) is configured to be illuminated by the part of the light emerging outside of the light guide. At least one part of the facing member (4) is configured to increase in luminance of the facing surface (41) in accordance with an increase in a distance from the light source (2) along the length of the light guide (3).

The light emitting device (1) of the first aspect can uniform the distribution of luminance of the light guide (3) (improve the uniformity of luminance) compared with a case where the facing surface (41) of the facing member (4) has the uniform distribution of luminance (or the facing member (4) is absent). Additionally, in contrast to the conventional example disclosed in Document 1, the light emitting device (1) of the first aspect does not need subjecting the light guide (3) to special treatment. Consequently, the light emitting device (1) of the first aspect can improve uniformity of luminance while suppressing an increase in production cost.

The light emitting device (1) of the second aspect according to the present disclosure would be realized in combination with the first aspect. In the light emitting device (1) of the second aspect, the at least one part of the facing member (4) is configured to gradually increase in the luminance of the facing surface (41) in accordance with the increase in the distance from the light source (2) along the length.

Consequently, the light emitting device (1) of the second aspect can further improve uniformity of luminance.

The light emitting device (1) of the third aspect according to the present disclosure would be realized in combination with the first or second aspect. In the light emitting device (1) of the third aspect, the at least one part of the facing member (4) is configured to reflect, by the facing surface (41), light emerging from a peripheral surface (31) of the light guide (3) facing the facing surface (41), and to increase a reflectivity per unit area of the facing surface (41) in accordance with an increase in the distance from the light source (2) along the length.

The light emitting device (1) of the third aspect can facilitate adjustment of distribution of luminance of the facing surface (41) of the facing member (4).

The light emitting device (1) of the fourth aspect according to the present disclosure would be realized in combination with the third aspect. In the light emitting device (1) of the fourth aspect, the at least one part of the facing member (4) includes, in the facing surface: a black region (L1) which is closest to the light source (2) along the length; and a stripe region which is different than the black region (L1) and increases a pitch between strips in proportion to distances from the light source (2) to the strips along the length.

The light emitting device (1) of the fourth aspect can more facilitate adjustment of distribution of luminance of the facing surface (41) of the facing member (4).

The light emitting device (1) of the fifth aspect according to the present disclosure would be realized in combination with the third aspect. In the light emitting device (1) of the fifth aspect, the at least one part of the facing member (4) includes, in the facing surface; a first region (L1) which is closest to the light source (2) along the length; a second region (L2) which is farther from the light source (2) than the first region (L1); and a third region (L3) which is further from the light source (2) than the second region (L2) along the length. The first region (L1) is a black region. The third region (L3) is a white region. The second region (L2) includes a polka-dot pattern in which white round dots are on a black background. In the polka-dot pattern of the second region (L2), the white round dots have diameters increasing in proportion to distances from the light source (2) along the length.

The light emitting device (1) of the fifth aspect can more facilitate adjustment of distribution of luminance of the facing surface (41) of the facing member (4).

The light emitting device (1) of the sixth aspect according to the present disclosure would be realized in combination with the third aspect. In the light emitting device (1) of the sixth aspect, the at least one part of the facing member (4) includes, in the facing surface; a first region (L1) which is closest to the light source (2) along the length; a second region (L2) which is further from the light source (2) than the first region (L1) along the length; and a third region (L3) which is further from the light source (2) than the second region (L2) along the length. The first region (L1) is a black region. The third region (L3) is a white region. The second region (L2) includes a lattice pattern. The lattice pattern of the second region (L2) includes black parts having areas decreasing in proportion to distances from the light source (2) to the black parts along the length.

The light emitting device (1) of the sixth aspect can more facilitate adjustment of distribution of luminance of the facing surface (41) of the facing member (4).

The light emitting device (1) of the seventh aspect according to the present disclosure would be realized in combination with any one of the first to sixth aspects. In the light emitting device (1) of the seventh aspect, the facing member (4) includes a trough shape with a recess (40). The light guide (3) is in the recess (40) of the facing member (4). An inner peripheral surface of the recess (40) is the facing surface (41).

The light emitting device (1) of the seventh aspect can facilitate positioning the light guide (3) to face the facing surface (41) by way of inserting the light guide (3) into the recess (40).

The light emitting device (1) of the eighth aspect according to the present disclosure would be realized in combination with the seventh aspect. In the light emitting device (1) of the eighth aspect, the facing member (4) supports the light guide (3) in the recess (40).

The light emitting device (1) of the eighth aspect can decrease the number of parts thereof and lower the production cost compared with a case where the light guide (3) is supported by a support which is a separate part from the facing member (4).

The light emitting device (1) of the ninth aspect according to the present disclosure would be realized in combination with the eighth aspect. In the light emitting device (1) of the ninth aspect, the facing member (4) supports the light source (2), with the light source (2) facing the entrance surface (30) of the light guide (3).

The light emitting device (1) of the ninth aspect can decrease the number of parts thereof and lower the production cost compared with a case where the light source (2) is supported by a support which is a separate part from the facing member (4).

The light emitting device (1) of the tenth aspect according to the present disclosure would be realized in combination with any one of the first to sixth aspects. The light emitting device (1) of the tenth aspect includes a reflector (the support 6) which faces the light guide (3), with the facing member (5) being between the reflector and the light guide (3), and includes a surface which faces the light guide (3) as a reflection surface. The at least one part of the facing member (5) is light-transmissive and includes a transmissivity which increases in accordance with the increase in the distance from the light source (2) along the length.

The light emitting device (1) of the tenth aspect can facilitate adjustment of distribution of luminance of the facing surface (50) of the facing member (5).

The light emitting device (1) of the eleventh aspect according to the present disclosure would be realized in combination with the tenth aspect. The light emitting device (1) of the eleventh aspect includes a support (6) including an accommodating part (60), the accommodating part having a second length and accommodating the facing member (4). The accommodating part (60) is the reflector.

The light emitting device (1) of the eleventh aspect can decrease the number of parts thereof and lower the production cost due to the accommodating part (60) of the support (6) being the reflector.

The light emitting device (1) of the twelfth aspect according to the present disclosure would be realized in combination with the eleventh aspect. In the light emitting device (1) of the twelfth aspect, the support (6) includes a first side wall (61) protruding from a first end of the accommodating part (60), and a second side wall (62) protruding from a second end of the accommodating part (60). The support (6) accommodates the light guide (3) in an inside space surrounded by the first side wall (61) and the second side wall (62).

The light emitting device (1) of the twelfth aspect can suppress change in posture of the light guide (3) in the accommodating part (60) due to presence of the first side wall (61) and the second side wall (62).

The light emitting device (1) of the thirteenth aspect according to the present disclosure would be realized in combination with any one of the first to sixth aspects. The light emitting device (1) of the thirteenth aspect includes an auxiliary light guide (7) having a second length and including an auxiliary entrance surface (70) for receiving the light emitted from the light source (the main light source 2A) or second light emitted from a different light source (the auxiliary light source 2B) than the light source (the main light source 2A), the auxiliary light guide (7) configured to guide the light or the second light received via the auxiliary entrance surface (70) along the second length in a direction away from the light source (2A, 2B) and to allow a second part of the light or the second light to emerge outside of the auxiliary light guide (7). The auxiliary light guide (7) faces an auxiliary facing surface (811) of the facing member (4) which is opposite the facing surface (the main facing surface 810). The facing member (81) is configured to receive the second part of the light or the second light emitted from the auxiliary light guide (7) via the auxiliary facing surface (811), and to emit the second part of the light or the second light via the facing surface (the main facing surface 810).

The light emitting device (1) of the thirteenth aspect can improve uniformity of luminance while suppressing an increase in production cost.

The light emitting device (1) of the fourteenth aspect according to the present disclosure would be realized in combination with the thirteenth aspect. In the light emitting device (1) of the fourteenth aspect, the at least one part of the facing member (81) is configured to increase a transmissivity of the second part of the light or the second light traveling from the auxiliary facing surface (811) to the facing surface (the main facing surface 810) in accordance with the increase in the distance from the light source along the length.

The light emitting device (1) of the fourteenth aspect can facilitate adjustment of distribution of luminance of the facing surface (the main facing surface 810) of the facing member (81).

The light emitting device (1) of the fifteenth aspect according to the present disclosure would be realized in combination with the thirteenth aspect. In the light emitting device (1) of the fifteenth aspect, a distance (XC) between the light guide (3A) and the auxiliary light guide (7) in a direction where the light guide (3A) faces the auxiliary light guide (7) decreases as the distance from the light source (2A) along the length increases.

The light emitting device (1) of the fifteenth aspect can facilitate adjustment of distribution of luminance of the facing surface (the main facing surface 810) of the facing member (81) by adjusting the distance (XC) between the light guide (3A) and the auxiliary light guide (7).

The light emitting device (1) of the sixteenth aspect according to the present disclosure would be realized in combination with any one of the thirteenth to fifteenth aspects. The light emitting device (1) of the sixteenth aspect includes a support (8) which includes the facing member (81) and supports the light guide (3A) and the auxiliary light guide (7).

The light emitting device (1) of the sixteenth aspect can facilitate adjustment of distribution of luminance of the facing surface (the main facing surface 810) of the facing member (81) compared with a case where the facing member and the support are realized by one part.

The light emitting device (1) of the seventeenth aspect according to the present disclosure would be realized in combination with the sixteenth aspect. In the light emitting device (1) of the seventeenth aspect, the facing member (81) is between the light guide (3A) and the auxiliary light guide (7).

The light emitting device (1) of the eighteenth aspect according to the present disclosure would be realized in combination with the first aspect. The light emitting device (1) of the eighteenth aspect includes a support (6) which includes the facing member (5) and supports the light guide (3).

The light emitting device (1) of the eighteenth aspect can facilitate adjustment of distribution of luminance of the facing surface (50) of the facing member (5) compared with a case where the facing member and the support are realized by one part.

As apparent from the above, the moving object (the vehicle 9) of the nineteenth aspect according to the present disclosure includes: the light emitting device (I) of any one of the first to eighteenth aspects; and a body (the vehicular body 90) in which the light emitting device (1) is mounted.

The moving object (the vehicle 9) of the nineteenth aspect can improve uniformity of luminance while suppressing an increase in production cost.

As apparent from the above, the light emitting device (1) of the twentieth aspect according to the present disclosure includes a light guide (3) having a length and including an entrance surface (30), the entrance surface (30) for receiving light emitted from a light source (2), the light guide (3) configured to guide the light received via the entrance surface (30) along the length in a direction away from the light source (2) and to allow a part of the light guided along the length to emerge outside of the light guide (3). The light emitting device (1) of the twentieth aspect further includes a facing member (4) including a facing surface (41), the facing surface (41) extending along the length of the light guide (3) and facing the light guide (3), the facing member (4) configured to be illuminated by the part of the light emerging outside of the light guide (3). At least one part of the facing member (4) is configured to increase in luminance of the facing surface (41) in accordance with an increase in a distance from the light source (2) along the length of the light guide (3).

The light emitting device (1) of the twentieth aspect can uniform the distribution of luminance of the light guide (3) (improve the uniformity of luminance) compared with a case where the facing surface (41) of the facing member (4) has the uniform distribution of luminance (or the facing member (4) is absent). Additionally, in contrast to the conventional example disclosed in Document 1, the light emitting device (1) of the twentieth aspect does not need subjecting the light guide (3) to special treatment. Consequently, the light emitting device (1) of the twentieth aspect can improve uniformity of luminance while suppressing an increase in production cost.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A light emitting device, comprising:
a light source for emitting light;
a light guide having a length and including an entrance surface, the entrance surface for receiving the light emitted from the light source, the light guide configured to guide the light received via the entrance surface along the length in a direction away from the light source and to allow a part of the light guided along the length to emerge outside of the light guide; and
a facing member including a facing surface, the facing surface extending along the length of the light guide and facing the light guide, the facing member configured to be illuminated by the part of the light emerging outside of the light guide,
wherein at least one part of the facing member is configured to increase in luminance of the facing surface in accordance with an increase in a distance from the light source along the length of the light guide.

2. The light emitting device according to claim 1, wherein
the at least one part of the facing member is configured to gradually increase in the luminance of the facing surface in accordance with the increase in the distance from the light source along the length.

3. The light emitting device according to claim 1, wherein
the at least one part of the facing member is configured to reflect, by the facing surface, light emerging from a peripheral surface of the light guide facing the facing surface, and to increase a reflectivity per unit area of the facing surface in accordance with the increase in the distance from the light source along the length.

4. The light emitting device according to claim 3, wherein
the at least one part of the facing member includes, in the facing surface:
a black region which is closest to the light source along the length; and
a stripe region which is different than the black region and increases a pitch between strips in proportion to distances from the light source to the strips along the length.

5. The light emitting device according to claim 3, wherein
the at least one part of the facing member includes, in the facing surface:
a first region which is closest to the light source along the length;
a second region which is further from the light source than the first region along the length; and
a third region which is further from the light source than the second region along the length,
the first region is a black region,
the third region is a white region,
the second region includes a polka-dot pattern in which white round dots are on a black background, and
in the polka-dot pattern of the second region, the white round dots have diameters increasing in proportion to distances from the light source to the dots along the length.

6. The light emitting device according to claim 3, wherein
the at least one part of the facing member includes, in the facing surface:
a first region which is closest to the light source along the length;
a second region which is further from the light source than the first region along the length; and
a third region which is further from the light source than the second region along the length,
the first region is a black region,
the third region is a white region,
the second region includes a lattice pattern, and
the lattice pattern of the second region includes black parts having areas decreasing in proportion to distances from the light source to the black parts along the length.

7. The light emitting device according to claim 1, wherein
the facing member includes a trough shape with a recess,
the light guide is in the recess of the facing member, and
an inner peripheral surface of the recess is the facing surface.

8. The light emitting device according to claim 7, wherein
the facing member supports the light guide in the recess.

9. The light emitting device according to claim 8, wherein
the facing member supports the light source, with the light source facing the entrance surface of the light guide.

10. The light emitting device according to claim 1, further comprising:
a reflector which faces the light guide, with the facing member being between the reflector and the light guide, and includes a surface which faces the light guide as a reflection surface,
wherein the at least one part of the facing member is light-transmissive and includes a transmissivity which increases in accordance with the increase in the distance from the light source along the length.

11. The light emitting device according to claim 10, further comprising:
a support including an accommodating part, the accommodating part having a second length and accommodating the facing member,
wherein the accommodating part is the reflector.

12. The light emitting device according to claim 11, wherein
the support includes a first side wall protruding from a first end of the accommodating part, and a second side wall protruding from a second end of the accommodating part, and
the support accommodates the light guide in an inside space surrounded by the first side wall and the second side wall.

13. The light emitting device according to claim 1, further comprising:
an auxiliary light guide having a second length and including an auxiliary entrance surface for receiving the light emitted from the light source or second light emitted from a different light source than the light source, the auxiliary light guide configured to guide the light or the second light received via the auxiliary entrance surface along the second length in a direction away from the light source and to allow a second part of the light or the second light to emerge outside of the auxiliary light guide,
wherein the auxiliary light guide faces an auxiliary facing surface of the facing member which is opposite the facing surface, and
the facing member is configured to receive the second part of the light or the second light emitted from the auxiliary light guide via the auxiliary facing surface, and to emit the second part of the light or the second light via the facing surface.

14. The light emitting device according to claim 13, wherein
the at least one part of the facing member is configured to increase a transmissivity of the second part of the light or the second light traveling from the auxiliary facing surface to the facing surface in accordance with the increase in the distance from the light source along the length.

15. The light emitting device according to claim 13, wherein
a distance between the light guide and the auxiliary light guide in a direction where the light guide faces the auxiliary light guide decreases as the distance from the light source along the length increases.

16. The light emitting device according to claim 13, further comprising:
a support which includes the facing member and supports the light guide and the auxiliary light guide.

17. The light emitting device according to claim 16, wherein
the facing member is between the light guide and the auxiliary light guide.

18. The light emitting device according to claim 1, further comprising:
a support which includes the facing member and supports the light guide.

19. A moving object, comprising:
the light emitting device according to claim 1; and
a body in which the light emitting device is mounted.

20. A light emitting device, comprising:
a light guide having a length and including an entrance surface, the entrance surface for receiving light emitted from a light source, the light guide configured to guide the light received via the entrance surface along the length in a direction away from the light source and to allow a part of the light guided along the length to emerge outside of the light guide; and
a facing member including a facing surface, the facing surface extending along the length of the light guide and facing the light guide, the facing member configured to be illuminated by the part of the light emerging outside of the light guide,
wherein at least one part of the facing member is configured to increase in luminance of the facing surface in accordance with an increase in a distance from the light source along the length of the light guide.
